(19) United States
(12) Patent Application Publication
(10) Pub. No.: US 2016/0085975 A1
(43) Pub. Date: Mar. 24, 2016

(54) Constrained Information Transfer

(71) Applicant: SafeNet, Inc., Belcamp, MD (US)

(72) Inventors: Iqbal Dar, Marriottsville, MD (US); Chao Jiang, Ellicott City, MD (US); Chris Dunn, Manotick (CA); Shailesh Gajera, Ellicott City, MD (US)

(73) Assignee: SAFENET, INC., Belcamp, MD (US)

(21) Appl. No.: 14/490,093

(22) Filed: Sep. 18, 2014

(51) Int. Cl. G06F 21/62; H04L 29/08

(52) U.S. Cl. CPC G06F 21/62; H04L 67/1095

(57) ABSTRACT

A secure processing facility has a plurality of workstations, with associated computers to provide data to, and/or receive data from, the workstations. The computers are provided with a visual display unit, and display machine-readable data codes on the display. The computers are provided with a scanner to read the machine-readable data codes on the display of another of the computers. The computers have no other connection to receive or transmit machine readable data. A method of operating the facility includes processing a workpiece at a first workstation. A display of the computer of the first workstation displays a data code containing data related to the processing of the workpiece. The scanner of the computer associated with a second workstation scans the data code. The workpiece is transferred from the first workstation to the second workstation. The workpiece is processed at the second workstation.

### BACKGROUND

The present specification relates to constraining the transfer of information within and out from a secure environment, for example, a secure manufacturing facility.

It is well known for manufacturing process to be carried out at a succession of work-stations, each of which performs one or more manufacturing and/or testing steps. It is well-known for information relating to a product being manufactured to accompany that product. A work-station performing one step may require information about a previous manufacturing step, or the results of a previous testing step, or may simply require to be reassured that all previous manufacturing steps have been performed, and all previous tests have been performed and passed.

It is also well-known for a manufactured product to be accompanied by, or associated with, a data report when the product leaves the manufacturing facility.

It is highly desirable for the information to be transferred in machine-readable form, to avoid the delay, cost, and error-rate associated with manual data entry.

It has been proposed to connect the different work-stations through a network. However, general-purpose computer networks create a security vulnerability, because they do not constrain the amount, the nature, or the direction of data flows. A network can allow unrestricted information from a manufacturing station to be transferred to another manufacturing station, or can allow a message containing information to be transferred to a manufacturing station that should not receive that message. More seriously, a network can allow an outsider to hack into the “secure” facility, to steal information or plant malware.

There is therefore a need for methods and systems that will allow machine readable data transfer within and out from secure manufacturing and other facilities, while effectively constraining both the content and the destination of the data transfers.

### SUMMARY

According to one embodiment, there are provided systems, methods, and computer programs by which one computer displays machine-readable coded data on a visual display unit (VDU), another computer reads the coded data using a camera, scanner, or other image capture device, and at least the first computer is not connected to any network other than through machine-readable coded data on visual display units and image capture devices operative to read the coded data.

According to an embodiment, there is provided a secure facility including several workstations with associated computers. The computers are provided with VDUs and image capture devices. In normal operation, the only machine-readable communication between the computers is by one computer displaying coded data on its VDU and another computer capturing that data with its image capture device. In normal operation, the only machine-readable communication between a computer within the facility and a computer outside the facility is by a computer within the facility displaying coded data on its VDU and a computer outside the facility capturing that data with its image capture device.

“Normal operation” of a secure manufacturing facility includes strong restraints on unauthorized activities that may compromise security. In an example, access to the facility is restricted to specific authorized individuals, and even they are under continual video surveillance. All unused data ports to computers are both physically protected by covers that cannot be quickly removed, and disabled in the operating system, requiring a top-level administrator password to enable them. Used data ports, where possible, have their authorized connectors physically attached in a way that cannot be quickly removed, and are controlled in software to prevent unauthorized devices from being installed. Any authorized portable devices are individually serialized, and are tracked logically while they are connected to a computer and physically when they are away from the computer.

In this embodiment, each computer capturing the coded data may validate that data, to ensure that the data is proper for the capturing computer to process. In a simple case, the capturing computer may validate the actual data, to ensure that the data contains valid entries for specific fields of data. However, the data flows may be further constrained. For example, the coded data may be encrypted, and different computers may have different encryption keys, so that a computer cannot decrypt a message not intended for that computer. In one embodiment, each pair of computers that are authorized to communicate has a different encryption key. If an asymmetric cipher is used, then each computer may have only one key of a pair, and encryption keys may be segregated from decryption keys. Then, the computers can be configured so that communication is possible in only one direction or in both directions.

In addition, or as an alternative, the physical VDUs and image capture devices may be fixed in position, or attached to the computers by short leads, so that it is impossible for certain computers to capture the coded data from other computers without physically altering the setup of the facility.

The coded data displayed on the VDU may be in the form of a QR code or other generally used data code.

One aspect of the present application provides a secure processing facility, comprising: a plurality of work stations, having associated computers operative to provide data to, or to receive data from, or to both provide data to and receive data from said work stations; at least some of said computers being provided with a visual display unit, and being programmed to display machine-readable data codes on said visual display unit; at least some of said computers being provided with a scanner operative to read said machine-readable data codes on said visual display unit of another said computer; at least some of said computers being free from any other connection to receive or transmit machine readable data.

The computers provided with a visual display unit may be programmed to display the machine-readable data codes including an identification of the displaying computer, and the computers provided with a scanner may be programmed to accept such data codes from some displaying computers and to reject such data codes from other displaying computers.

The visual display units and the scanners may be so located as to restrict the scanners from reading the codes from at least some visual display units.

Where there is more than one computer provided with a visual display unit and programmed to display machine-readable data codes including encrypted data, different computers may use different encryption keys. The computers provided with scanners may be provided with decryption keys corresponding only to certain ones of those encryption keys.

Two or more work stations may be operative to work successively on a workpiece, and the associated computers may then be programmed to pass the data associated with a specific workpiece by displaying and scanning the codes to successive computers so that when the workpiece is at a given work station, the associated data is at the computer associated with the given work station.

Another aspect of the present application provides a method of operating a secure processing facility, wherein the facility comprises: a plurality of work stations, having associated computers operative to provide data to, or to receive data from, or to both provide data to and receive data from the work stations, at least some of the computers being provided with a visual display unit, and being programmed to display machine-readable data codes on the visual display unit, at least some of the computers being provided with a scanner operative to read the machine-readable data codes on the visual display unit of another of the computers, and at least some of the computers being free from any other connection to receive or transmit machine readable data. In an embodiment, the method comprises: processing a workpiece at a first work station; displaying on such a visual display unit of the associated computer of the first work station a data code containing data related to the processing of that workpiece at the first work station; scanning the data code with the scanner of such an associated computer of a second work station; transferring the workpiece from the first work station to the second work station; and processing the workpiece at the second work station.

Data contained in the data code may be used in the processing of the workpiece at the second work station.

Data related to the processing of the workpiece at the second work station may be combined with the data contained in the data code received from the first work station. A data code containing the combined data may then be displayed on a visual display unit of the associated computer of the second work station.

The data code displayed by either the first or the second work station may be scanned with the scanner of a computer associated with a third work station. The third work station computer may then determine that the third work station is not an intended recipient of the data code; and the third work station computer may then drop the data code.

Determining that the third work station is not an intended recipient of the data code may comprise the third work station reading a header in the data code identifying the first work station, and the third work station determining that the first work station is not a source of data codes intended for the third work station.

The data code may comprise encrypted data, and determining that the third work station is not an intended recipient of the data code may comprise the third work station not possessing a decryption key for the encrypted data.

Determining that the third work station is not an intended recipient of the data code may comprise the third work station reading the data contained in the data code, and the third work station determining that data required by the third work station is not present.

Another aspect of the present application provides a method of configuring a facility as mentioned above, comprising: identifying the work stations; generating a master secure input map listing all those ordered pairs of work stations and only those ordered pairs of work stations, such that a first work station of each pair should send data to the second work station of each pair; for each given work station, extracting from the master secure input map a station secure input map listing at least one of work stations that should send data to the given work station, and work stations that should receive data from the given work station; and configuring each given work stations so as to prevent data transmissions that are not listed in the respective station secure input map.

Another aspect of the present application provides a non-volatile computer readable storage medium containing computer code operative to cause a suitable computer to act as a mentioned computer in a facility or method as mentioned above.

Other aspects of the invention include methods, computers and computer systems, computer programs, and non-transitory computer-readable storage media containing computer programs.

### BRIEF DESCRIPTION OF THE DRAWINGS

The above and other aspects, features, and advantages of the present invention may be more apparent from the following more particular description of embodiments thereof, presented in conjunction with the following drawings. In the drawings:

FIG. 1 is a schematic diagram of an embodiment of a computer system.

FIG. 2 is a schematic diagram of an embodiment of a manufacturing facility.

FIG. 3 is an illustration of an example of a data code.

FIG. 4 is a flow-chart.

FIG. 5 is a flow-chart showing a detail of FIG. 4.

### DETAILED DESCRIPTION OF THE ILLUSTRATED EMBODIMENTS

A better understanding of various features and advantages of the present methods and devices may be obtained by reference to the following detailed description of illustrative embodiments and accompanying drawings. Although these drawings depict embodiments of the contemplated methods and devices, they should not be construed as foreclosing alternative or equivalent embodiments apparent to those of ordinary skill in the subject art.

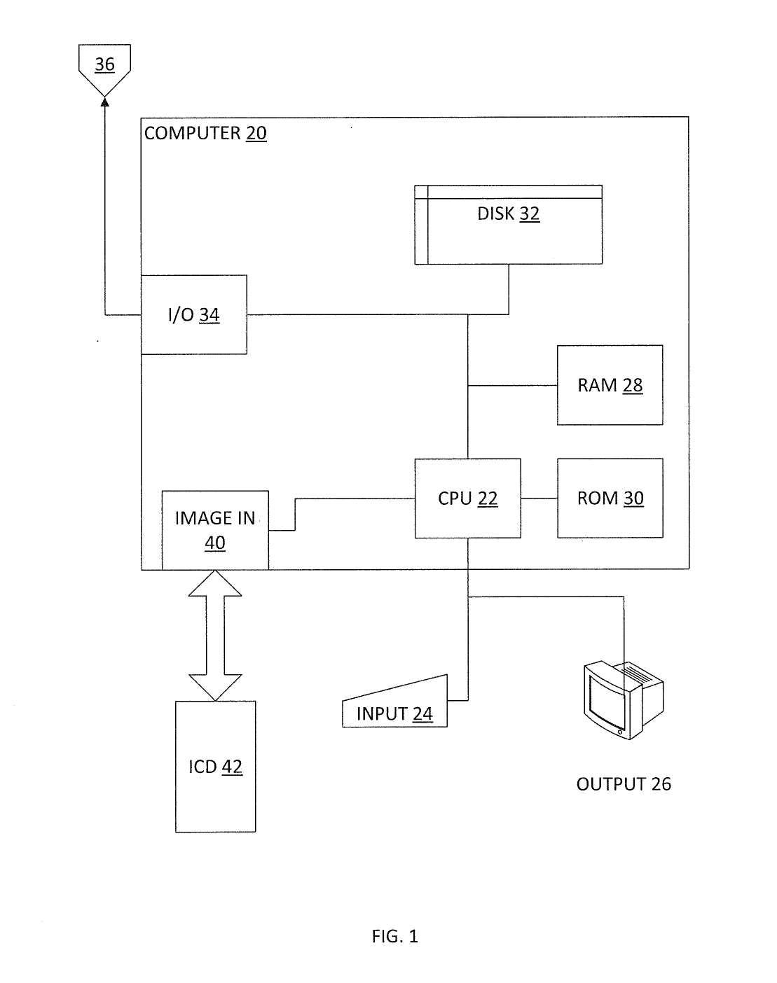

Referring to the drawings, and initially to FIG. 1, an example of a computer apparatus indicated generally by the reference number 20 comprises, among other equipment, a processor 22, a keyboard, mouse, or other human input device 24, visual display unit (VDU) 26, random access memory (RAM) 28, read-only memory (ROM) 30, magnetic disks or other long-term non-volatile storage 32. An interface 34 connects the computer 20 to a manufacturing or testing station 36. Computer apparatus 20 also includes an image input port 40, into which a camera, scanner, or other image capture device 42 is connected. Although in the interests of simplicity only one VDU 26 is shown, the computer 20 may have separate VDUs dedicated to human interface (associated with the keyboard 24) and to data transfer (associated with the scanner 42). The computer 20 may have more than one VDU 26 and/or more than one scanner 42 for data transfer to and/or from different other computers.

Unusually, the computer 20 does not have any conventional network connection or external removable disk or removable memory port. The connectors for the keyboard 24, VDU 26, I/O 34, and image input 40 are designed so that they cannot easily be diverted for use as general purpose data input or output connections. For example, the external devices 24, 26, 36, 42 may be hard wired to computer 20, without removable connectors. If there are removable connectors, they may be non-standard connectors, or the plugs may be fixed into the sockets with security screws requiring a special tool to remove them. Additionally, or as an alternative, the computer 20 may be programmed to verify any external device connected to any physical port, and not to communicate with any device not authorized to connect to that port.

In an embodiment, the computer 20 is configured using a brand-new computer that has never been exposed to an unsecured computer network. In an embodiment, the computer 20 may be at least a computer of which the hard disk 32 has been replaced or completely wiped and reformatted, and that has in the meantime never been exposed to an unsecured computer network, but that may not be sufficiently secure for some applications.

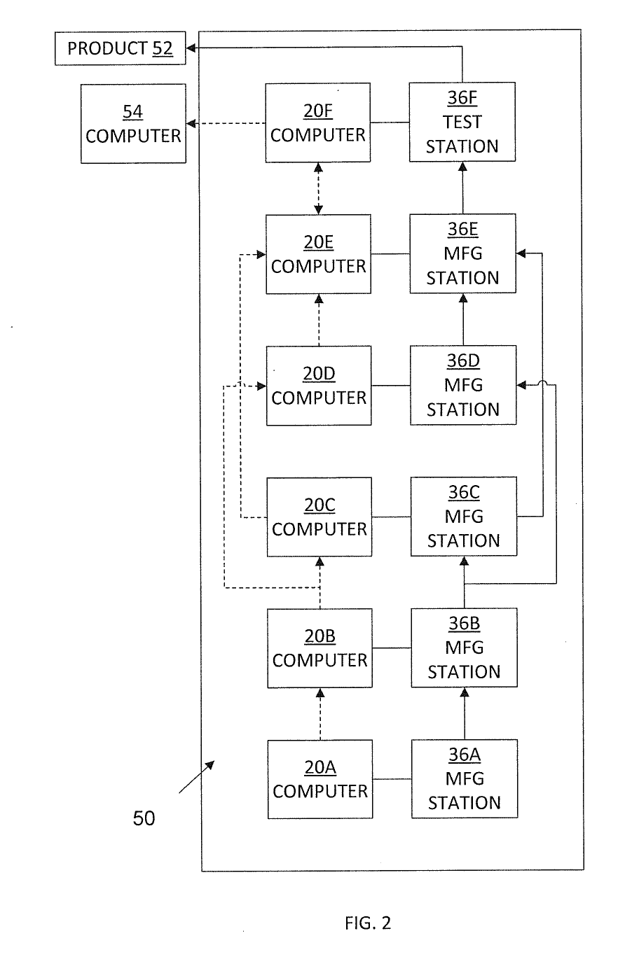

Referring now also to FIG. 2, an embodiment of a secure manufacturing facility, indicated generally by the reference numeral 50, comprises a series of manufacturing and testing stations 36 (identified individually as 36A, 36B, . . . 36F), each connected to a respective computer 20 (identified individually as 20A, 20B, . . . 20F). The computers 20A through 20F may be as shown in FIG. 1, except that computer 20A may omit the scanner 42, which in the configuration of FIG. 2 is never used.

The facility 50 is secured in any appropriate conventional ways, including access control to the facility, password, passcard, and/or biometric logon control for computers 20, and the like.

As is symbolized by the solid arrows in FIG. 2, a product being manufactured passes from a first workstation 36A to the second station 36B, then to either the third station 36C or the fourth station 36D, then to the fifth station 36E, then to the sixth station 36F, from which the finished product 52 exits the facility. In this example, the third station 36C and the fourth station 36D are alternatives, and each product 52 must go to one or other of those stations, but not both.

As is symbolized by the broken arrows in FIG. 2, accompanying data relating to the product passes from a first computer 20A associated with the first workstation 36A to the second computer 20B, then to either the third computer 20C or the fourth computer 20D, then to the fifth computer 20E, then to the sixth computer 20F, from which the data to accompany the finished product 52 exits the facility to an external computer 54.

Alternatively, computer 54 may be external to production line 50, but within a larger secure facility, if it is considered desirable to compartmentalize the flow of information and products 52 within the larger facility.

All of the data transfers are from a data code displayed on the VDU 26 connected to one computer 20 to a scanner 42 connected to the next computer 20. In most cases, data flows in only one direction. However, by way of example, the last station 36F is shown as a test station, data from which is required to provide feedback to the computer 20E of manufacturing station 20E, There is therefore a two-way data link between computers 20E and 20F.

Data flow between the computers 20A to 20F and 54 is constrained at various levels. First, the physical location of the VDUs 26 and scanners 42 limits data flow. For example, computer 20B cannot read the data from computer 20C, because the VDU 26 of computer 20C and the scanner 42 of computer 20B are facing away from each other. Computer 20F may be provided with two separate VDUs 26, facing in different directions, so that external computer 54 cannot see the test results being transferred from computer 20F to computer 20E.

The link to external computer 54 is especially sensitive, because any breach of security on that link can result in data improperly entering or leaving the secure facility 50. The link may be through a small physical window in a physical wall enclosing secure facility 50, with the window positioned so that no other VDU 26 within secure facility 50 is visible from outside the window. Computer 20F is programmed so that no information is ever displayed on the VDU 26 visible through the window, except for information that is intended to be released to accompany the product 52. The data code displayed may be in a non-standard format, and especially may have a missing or non-standard header, so that if a passer-by attempts to capture the data code with a standard smart phone or similar, the smart phone is likely to reject the data code as unreadable.

External computer 54 is not programmed to generate data codes readable by any of the scanners 42 inside secure facility 50, and, if practical, all scanners 42 inside the secure facility 50 are arranged so that they could not read a VDU 26 outside the secure facility 50.

The scanner 42 of computer 20F may be able to see the VDU 26 of computer 20A, but may not be able to read the displayed data code, because the two computers are too far apart. Programming each computer 20 to read only data codes displayed at a narrow range of sizes in scanner pixels, and therefore at a specific distance from the scanner 42, both restricts undesired capture of data codes from the wrong display 26 and also simplifies the programming.

The scanners 42 may be on fixed mounts facing their respective VDUs 26. Alternatively, the scanners 42 may be hand-held. That requires the presence of a human operator whenever data is transferred, which may be desirable supervision. The operator can also enter keystrokes manually on the keyboard 24 of the source computer 20 to confirm that a data code has been successfully scanned, request that a data code be re-displayed, or respond to any error messages. If the scanner 42 is hand-held, a short flexible cable is desirable, to reduce the number of VDUs 26 that the scanner can reach. However, a wireless link may be used. If a wireless link is used, it is desirably highly encrypted, using unique encryption keys, to prevent both eavesdropping from outside the facility 50 and inadvertent capture of the data code by the wrong receiver within the facility 50.

Second, different formats may be used for communication between different pairs of computers 20. A computer 20 receiving a data code not intended for it may then reject the data code as inappropriate, or may simply be unable to read it.

Third, the displayed data codes may be encrypted, and by limiting the distribution of encryption and decryption keys to the different computers 20, it may be essentially impossible for certain pairs of computers to communicate with each other. By using a asymmetrical cipher, and segregating encryption keys from decryption keys, it may be possible for a given pair of computers to communicate in only one direction.

Fourth, each data code may include a-header explicitly identifying which computer is sending that data code. The computer receiving the data code may immediately read that header, and drop any data code from a sending computer that the receiving computer is not supposed to receive data codes from.

Fifth, the receiving computer may validate the content of the data. For example, if manufacturing station 36B should process only products 52 that have already been processed by manufacturing station 36A, then computer 20B may validate an incoming data code to ensure that computer 20A has already entered valid data in all fields recording the processing in station 36A. If a code is received without those entries, then computer 20B may drop the incoming data code or, if the product matching the data code arrives at manufacturing station 36B, computer 20B may raise an alarm.

The physical product 52 is provided with a securely attached label or other marking that is both machine-readable and human-readable, and uniquely identifies the individual instance of the product 52. The machine-readable marking may be a barcode. The barcode is then scanned whenever it is necessary or desirable to confirm the identity of the instance of the product 52. In particular, when a work station 36 receives a product 52 and a data code, before the work station 36 attempts to process the product 52, the barcode on the product 52 may be scanned and verified against the data code. If they do not relate to the same instance of the product 52, the computer 20 of the work station 36 may raise an alarm.

At computers 20C and 20D in FIG. 1, an additional check is necessary, because both of those computers are allowed to receive data codes from computer 20B, but each product 52 goes to only one of the associated workstations 36C, 36D. Therefore, either the data code from computer 20B should specify which of workstations 36C, 36D the associated product is being sent to (if that information is available) or each of the receiving computers 20C, 20D needs to check whether its associated workstations 36C, 36D has received the product in question.

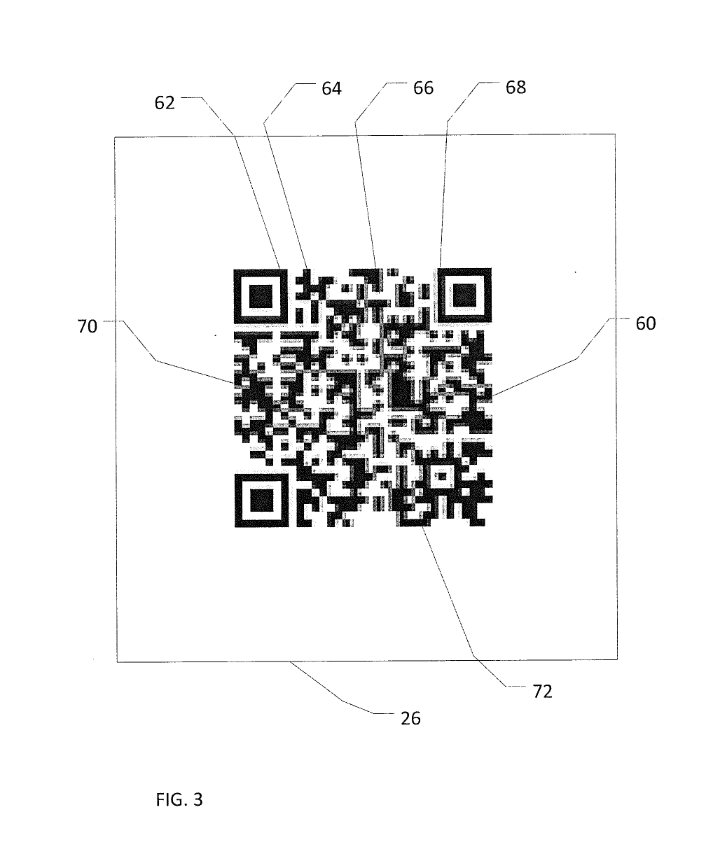

Referring now also to FIG. 3, one example of a QR code 60 displayed on a VDU 26 comprises a header area 62 including a section 64 identifying the source computer, optionally a section 66 identifying the intended receiving computer, a section 68 specifying the number of pages in the transmission and the page number of the present code 60, a body area 70 containing actual data (which may be encrypted) and an error checking area 72 containing parity, checksum, or other error-check data for the code as a whole.

The format of the QR code 60 may be a standard QR code format, or may be a specialized format. In order to increase security, and reduce the risk of incorrect information flows, different pairs of computers 20 may use different formats. Where a specific format is limited to a specific pair of pairs of computers 20, part or all of the standard code header area 62, for example, the sections 64 and 66, may be unnecessary, and may be omitted.

An advantage of using QR and similar codes is that the amount of data allowed is small. Even the largest standard size, Version 40-L, allows only 2,953 bytes of data per page. That compels the use of tightly formatted data in the codes, strongly constraining what data can be transmitted, and greatly hindering any attempt to misuse the data codes to transmit unauthorized content. Typically, the data is notionally in the form of a database record, with each field assigned to a particular piece of information. Where practical, fixed field sizes are preferred, to eliminate the overhead of field delimiter characters.

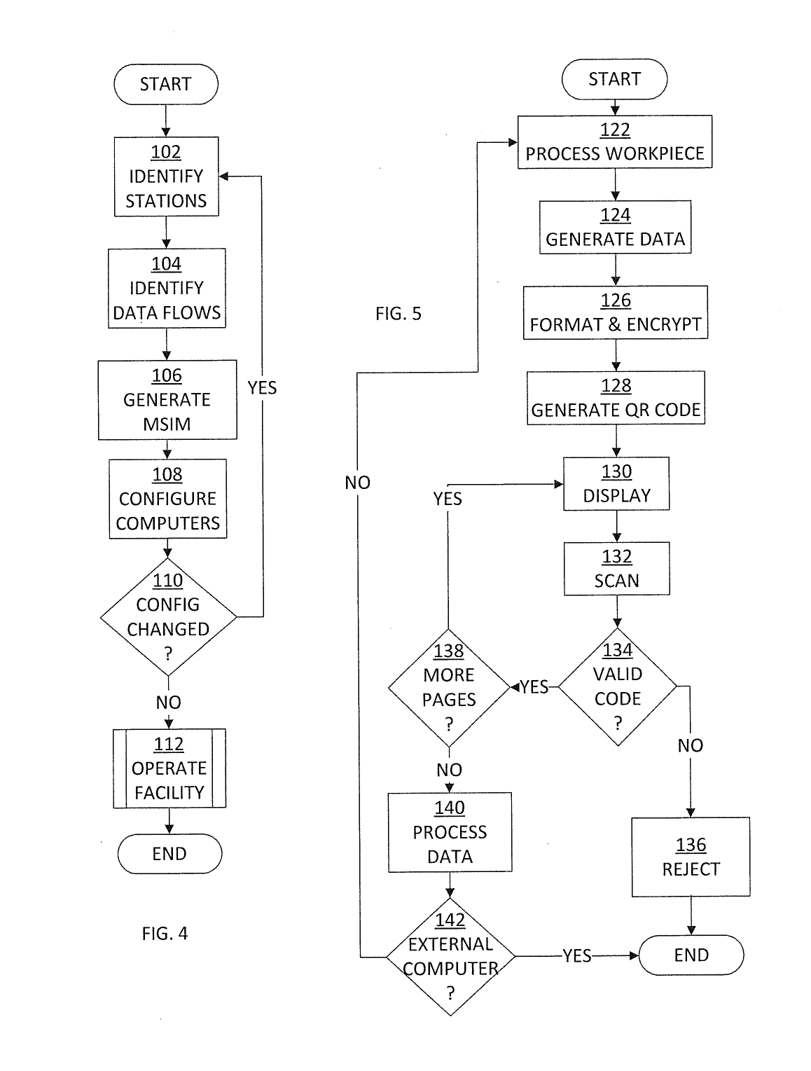

Referring now also to FIG. 4, in step 102, the manufacturing and testing stations 36 and the associated process steps are identified. For this purpose, any group of steps that will always be carried out at a single station 36, without being interrupted by a step at another station 36, may be treated as a single process step. However, if process steps are grouped in that way, it should be possible to ungroup them if a later revision of the process separates the steps.

In step 104, the data flows between computers 20 corresponding to the movements of products between the manufacturing and testing stations 36 are identified.

In step 106, a Master Secure Input Map (MSIM) is generated. The MSIM may consist essentially of a table listing, for each computer 20 that may originate a data code, which other computers 20 may receive a code from that computer. For example, for the configuration shown in FIG. 1, the MSIM would be as follows:

| Source | Receiver | Source | Receiver |
|---|---|---|---|
| A | B | A | B |
| B | C, D | B | C |
| C | E | B | D |
| D | E | C, D, F | E |
| E | F | E | F |
| F | E, 54 | F | 54 |

In step 108, each computer 20 is configured, by positioning its VDU or VDUs 26 and scanner or scanners 42, by installing encryption and decryption keys, by programming the source and receiver computers 20 with identifier headers, or otherwise, to enable communications approved in the MSIM, and to prevent communications not approved in the MSIM. Each computer 20 may be provided with a Station Secure Input Map (SSIM), which is an excerpt from the MSIM telling that computer which source devices that computer is permitted to receive data codes from.

In step 110, it is determined whether the configuration of the facility 50 has changed. If so, the process loops back to step 102 to regenerate the MSIM.

Assuming that the facility is not being reconfigured, in step 112 the facility is operated.

Referring now to FIG. 5, which is a detail of part of step 112 of FIG. 4, in step 122 a workstation 36 (which may be any of the workstations 36A to 36F of FIG. 1) performs manufacturing or testing on a product 52.

In step 124, the associated computer 20 generates appropriate data that needs to be forwarded to a later step. In step 126, the data is formatted and if desired encrypted. In step 128, the data is transformed into a QR code. The transformation may include adding an unencrypted header identifying the source computer 20 and the number of pages of data in the transmission, and computing and adding error checking bits. The QR code has a maximum of 2056 bits of data, so if the amount of data to be transmitted is greater than that, it is transmitted as a sequence of pages, each in the form of a different QR code.

In step 130, the QR code is displayed on the VDU 26 of the source computer 20.

In step 132, the QR code is scanned by another computer 20. In step 134, the receiving computer reads the source computer identifier from the header, and validates that source computer against the receiving computer's SSIM. If the source is not authorized, in step 136 the receiving computer rejects the scanned code, and takes no further action.

If the receiving computer is authorized to receive from the identified source computer (for example, only computer 20B is authorized to receive from computer 20A), then in step 138 the receiving computer checks the number of pages in the header. If the message is more than one page, the receiving computer 20 acknowledges receipt of the first page and the process loops back to step 130 and the source computer 20 displays the next page. When the last page has been received, the receiving computer 20 proceeds to step 140, and decrypts and processes the received data. Alternatively, depending on the content and format of the message, step 140 may proceed in parallel with the loop through steps 130, 132, 134, 138, so that the receiving computer 20 starts processing the information contained in the first page or pages of the message while a subsequent page is or pages are being displayed by the source computer 20 and scanned into the receiving computer, and so on.

Communications from the receiving computer to the source computer may be transmitted by a display screen 26 on the receiving computer being scanned by a scanner 42 attached to the source computer. However, if the amount of information transmitted is low, for example, merely indicating whether a page has been successfully captured, a much simpler display than a QR code on a monitor screen may be used. For example, a few lamps of different colors or in different locations may be enough. Alternatively if the transfer of information requires human assistance, for example, to hold a scanner 42 up to a screen 26, then the human operator could manually input the information on a keyboard or keypad 24 of the source computer.

The processing in step 140 typically includes at an early stage validating the received data to ensure that all steps that should be completed before the product 52 arrives at the associated work station 36 have been completed. That may merely require an explicit statement in the received data that the immediately preceding work station has processed the product 52 and, if the immediately preceding work station is a test station, that the product 52 passed the tests there. Where the immediately preceding work station 36 should have entered substantive data, the receiving work station computer 20 preferably validates that data to ensure that all necessary fields have been entered, and that the entered data values are valid and acceptable. The receiving computer 20 may also validate data from earlier work stations, or may assume that the immediately preceding computer 20 has already validated the earlier data.

At step 142, if the receiving computer is one of the computers 20B to 20F, then the process usually loops back to step 122, where the associated workstation 36B to 36F processes the product 52. If the source computer was computer 20F, and the receiving computer is computer 20E, then computer 20E may be using test data from test station 36F as feedback to adjust workstation 36E.

If at step 142 the receiving computer is the external computer 54, then the process ends. For this purpose, the external computer 54 may be a computer outside the secure facility 50, or if the secure facility 50 is compartmentalized, the external computer 54 may be the first computer 20 in a next compartment, where no information flows back from the next compartment to the previous compartment, and only limited information is permitted to flow from the previous compartment to the next compartment. If the external computer 54 is the first computer 20 in the next compartment, then the end of the present process of FIG. 5 may be immediately followed by the start of the process of FIG. 5 in the next compartment.

The receiving computer does not necessarily use all the information contained in the received data code for its own purposes. Some of the data may merely be forwarded from the receiving computer to a next computer at a next iteration of FIG. 5, either for use in a later workstation, or simply to contribute to a complete manufacturing history that is assembled as the data accompanies the product 52 down the production line.

Although specific embodiments have been described, various modifications are possible without departing from the spirit of the invention or the scope of the appended claims, and features of the different embodiments may be combined into one embodiment.

For example, the embodiment has been described as using a QR code. A generally used standard code format has the advantages that much of the hardware and software needed are readily available, extensively used, and therefore fairly bug-free. However, another form of code may be used. A non-standard proprietary code may be used, because it is less likely that a visitor or intruder with a standard smartphone or similar device could successfully capture the non-standard code. The number of pixels, and therefore the amount of data, in each page of code, may be determined by the resolution of the VDU 26 and the effective resolution of the scanner 42. The effective resolution of the scanner 42 is assessed in terms of the area on VDU 26 that is imaged onto one scanner pixel.

In the interests of simplicity, a secure facility 50 has been illustrated in which all the computers 20 of all the work stations 36 within the secure facility 50 are fully isolated, and can communicate only by displaying and scanning data codes. Alternatively, the isolated computers 20 could be mixed with networked computers, so that only certain key activities are confined to fully isolated computers. If data is sent only from an isolated computer 20 to a networked computer (as shown above for computers 20F and 54), the isolation of the isolated computer 20 is not compromised. If data is sent from a networked computer to the isolated computer 20, there is a theoretical risk that the incoming data code could contain improper material that would breach the isolation. That risk is minimized, because the very nature of the scanned data code fixes the maximum size of an incoming message, so that it can be rigorously quarantined within the receiving isolated computer 20.

Accordingly, reference should be made to the appended claims, rather than to the foregoing specification, as indicating the scope of the invention.

1. A secure processing facility, comprising:
a plurality of work stations, having associated computers operative to provide data to, or to receive data from, or to both provide data to and receive data from said work stations;
at least some of said computers being provided with a visual display unit, and being programmed to display machine-readable data codes on said visual display unit;
at least some of said computers being provided with a scanner operative to read said machine-readable data codes on said visual display unit of another said computer;
at least some of said computers being free from any other connection to receive or transmit machine readable data than through machine-readable coded data on visual display units and scanner operative to read machine-readable data codes.

2. The facility of claim 1, wherein said computers provided with a visual display unit are programmed to display said machine-readable data codes including an identification of the displaying computer, and wherein said computers provided with a scanner are programmed to accept said data codes from some displaying computers and to reject said data codes from other displaying computers.

3. The facility of claim 1, wherein said visual display units and said scanners are so located as to restrict said scanners from reading said codes from at least some visual display units.

4. The facility of claim 1, wherein different ones of said computers provided with a visual display unit are programmed to display said machine-readable data codes including data encrypted with different encryption keys, and said computers provided with a scanner are provided with decryption keys corresponding only to certain ones of said encryption keys.

5. The facility of claim 1, wherein different ones of said work stations are operative to work successively on a workpiece, and said computers are programmed to pass said data associated with said workpiece by displaying and scanning said codes to successive computers so that when the workpiece is at a given work station, the associated data is at the computer associated with the given work station.

6. A method of operating a secure processing facility, wherein the facility comprises: a plurality of work stations, having associated computers operative to provide data to, or to receive data from, or to both provide data to and receive data from said work stations, at least some of said computers being provided with a visual display unit, and being programmed to display machine-readable data codes on said visual display unit, at least some of said computers being provided with a scanner operative to read said machine-readable data codes on said visual display unit of another said computer, and at least some of said computers being free from any other connection to receive or transmit machine readable data than through machine-readable coded data on visual display units and scanner operative to read machine-readable data codes, the method comprising:
processing a workpiece at a first work station;
displaying on a said visual display unit of said associated computer of said first work station a data code containing data related to the processing of said workpiece at said first work station;
scanning said data code with said scanner of a said associated computer of a second work station;
transferring said workpiece from said first work station to said second work station; and
processing said workpiece at said second work station.

7. The method of claim 6, further comprising using data contained in said data code in the processing of said workpiece at said second work station.

8. The method of claim 6, further comprising combining with the data contained in said data code data related to the processing of said workpiece at said second work station, and displaying on a said visual display unit of said associated computer of said second work station a data code containing the combined data.

9. The method of claim 6, further comprising:
scanning said data code with said scanner of a said associated computer of a third work station;
determining by the third work station computer that the third work station is not an intended recipient of the data code; and
dropping the data code from the third work station computer.

10. The method of claim 9, wherein determining that the third work station is not an intended recipient of the data code comprises the third work station computer reading a header in the data code identifying the first work station, and the third work station computer determining that the first work station is not a source of data codes intended for the third work station.

11. The method of claim 9, wherein the data code comprises encrypted data, and determining that the third work station is not an intended recipient of the data code comprises the third work station computer not possessing a decryption key for the encrypted data.

12. The method of claim 9, wherein determining that the third work station is not an intended recipient of the data code comprises the third work station computer reading the data contained in the data code, and the third work station computer determining that data required by the third work station is not present.

13. A method of configuring a facility according to claim 1, comprising:
identifying the work stations;
generating a master secure input map listing all those ordered pairs of work stations and only those ordered pairs of work stations, such that a first work station of each pair should send data to the second work station of each pair;
for each given work station, extracting from the master secure input map a station secure input map listing at least one of work stations that should send data to said given work station, and work stations that should receive data from said given work station;
configuring each given work station so as to prevent data transmissions that are not listed in the respective station secure input map.

14. A non-volatile computer readable storage medium containing computer code operative to cause a suitable computer, in a secure processing facility comprising:
a plurality of work stations, having associated computers operative to provide data to, or to receive data from, or to both provide data to and receive data from said work stations;
at least some of said computers being provided with a visual display unit, and being programmed to display machine-readable data codes on said visual display unit;
at least some of said computers being provided with a scanner operative to read said machine-readable data codes on said visual display unit of another said computer;
at least some of said computers being free from any other connection to receive or transmit machine readable data than through machine-readable coded data on visual display units and scanner operative to read machine-readable data codes,
to act as one of said computers.

15. A non-volatile computer readable storage medium containing computer code operative, in a method of operating a secure processing facility, wherein the facility comprises: a plurality of work stations, having associated computers operative to provide data to, or to receive data from, or to both provide data to and receive data from said work stations, at least some of said computers being provided with a visual display unit, and being programmed to display machine-readable data codes on said visual display unit, at least some of said computers being provided with a scanner operative to read said machine-readable data codes on said visual display unit of another said computer, and at least some of said computers being free from any other connection to receive or transmit machine readable data than through machine-readable coded data on visual display units and scanner operative to read machine-readable data codes, the method comprising:
processing a workpiece at a first work station;
displaying on a said visual display unit of said associated computer of said first work station a data code containing data related to the processing of said workpiece at said first work station;
scanning said data code with said scanner of a said associated computer of a second work station;
transferring said workpiece from said first work station to said second work station; and
processing said workpiece at said second work station,
to cause a suitable computer provided with at least one of a visual display unit and a scanner and being free from any other connection to receive or transmit machine readable data than through machine-readable coded data on visual display units and scanner operative to read machine-readable data codes, to act as one of said computers, including carrying out at least one of said displaying and said scanning.
